(19) United States
(12) Patent Application Publication
(10) Pub. No.: US 2008/0072792 A1
(43) Pub. Date: Mar. 27, 2008

(54) Raw Material Solution for Metal Organic Chemical Vapor Deposition and Composite Oxide-Based Dielectric Thin Film Produced by Using the Raw Material

(75) Inventors: Akio Yanagisawa, Naka-gun (JP); Atsushi Itsuki, Naka-gun (JP); Nobuyuki Soyama, Naka-gun (JP)

Correspondence Address: DARBY & DARBY P.C., P.O. BOX 770, Church Street Station, New York, NY, 10008-0770, US

(73) Assignee: Mitsubishi Materials Corporation, Chiyoda-ku (JP)

(21) Appl. No.: 11/570,120

(22) PCT Filed: Jun. 10, 2005
(86) PCT No.: PCT/JP05/10665

§ 371 Date: Sep. 5, 2007

(30) Foreign Application Priority Data
Jun. 10, 2004 (JP) 2004-172664
Jun. 10, 2004 (JP) 2004-172665
Nov. 25, 2004 (JP) 2004-339802
Nov. 25, 2004 (JP) 2004-339803
May 31, 2005 (JP) 2005-158964
Jun. 8, 2005 (JP) 2005-167611

(51) Int. Cl. C09D 199/00

(52) U.S. Cl. 106/287.19; 106/287.18; 106/287.21

(57) ABSTRACT

A raw material solution for metal organic chemical vapor deposition having good film forming properties and excellent step coverage, and a composite oxide-based dielectric thin film produced by using the raw material, are provided. An improvement is made to the raw material solution for metal organic chemical vapor deposition having one or two or more organometallic compounds dissolved in an organic solvent, and the feature of the constitution lies in that the organic solvent is 1,3-dioxolane, or the organic solvent is a solvent mixture formed by mixing a first solvent consisting of 1,3-dioxolane, and a second solvent comprising one or two or more species selected from the group consisting of alcohols, alkanes, esters, aromatics, alkyl ethers and ketones, which is to be mixed with the 1,3-dioxolane.

### CROSS-REFERENCE TO PRIOR APPLICATION

This is a U.S. National Phase Application under 35 U.S.C. §371 of International Patent Application No. PCT/JP2005/010665 filed Jun. 10, 2005, and claims the benefit of Japanese Patent Application Nos. 2004-172664, filed Jun. 10, 2004, 2004-172665, filed Jun. 10, 2004, 2004-339802, filed Nov. 25, 2004, 2004-339803, filed Nov. 25, 2004, 2005-158964, filed May 31, 2005 and 2005-167611, filed Jun. 8, 2005, all of which are incorporated by reference herein. The International Application was published in Japanese on Dec. 22, 2005 as WO 2005/121400 A1 under PCT Article 21(2).

### TECHNICAL FIELD

The present invention relates to a raw material solution for metal organic chemical vapor deposition (hereinafter, referred to as MOCVD method) used for forming a composite oxide-based dielectric thin film by the MOCVD method, which film is used in memories such as dynamic random access memory (DRAM) or ferroelectric random access memory (FRAM), dielectric filter and the like, and a composite oxide-based dielectric thin film produced by using the raw material.

### BACKGROUND ART

This type of composite oxide-based dielectric thin film may be exemplified by lead titanate (PT), lead zirconate titanate (PZT), lead lanthanum zirconate titanate (PLZT), barium strontium titanate (BST) and the like. For the organometallic compound used as the raw material of the dielectric thin film, an organic metal complex having a diketone compound such as dipivaloylmethane ((CH₃)₃CCOCH₂COC(CH₃)₃; hereinafter, referred to as dpm) as the ligand, or a metal alkoxide such as [Zr(O-t-Bu)₄] is used in general. Metal raw materials such as Ti, Zr, Ta and the like use both of the metal alkoxide and the β-diketonate complex, while metal raw materials such as Sr and Ba mainly use the β-diketonate complex.

In regard to the method for forming a composite oxide-based dielectric thin film, a sol-gel method of forming a film of a metal alkoxide raw material on a substrate by spin coating, has been actively researched to date. Since the sol-gel method does not involve vaporization of metal components, the method is feasible for the control of film composition. However, the electrodes for DRAM capacitor have unevenness, and thus, a higher degree of integration would result in larger as well as more complicated unevenness; therefore, it is difficult in the spin coating method to form a dielectric thin film uniformly on the electrode, which serves as the substrate. For this reason, in the recent several years, in anticipation of high degrees of device integration, researches have been actively conducted on the formation of dielectric thin films by the MOCVD method exhibiting excellent step coverage (coatability to the surface of a complicated shape with unevenness).

The MOCVD method is a method of heating organometallic compounds, which are the precursors for various metals, under reduced pressure to vaporize the compounds, and transporting the vapors to a film forming chamber and thermally decomposing the vapors on a substrate, thereby attaching the produced metal oxides on the substrate. The MOCVD method is generally conducted due to the excellent step coverage compared with other film forming methods.

In the formation of dielectric thin films according to this MOCVD method, the initial practice was such that a raw material organometallic compound was directly heated and vaporized, and the generated vapor was sent to a film forming chamber to form a film. However, the organometallic compound raw materials, in particular, the compounds such as dpm complex which is recommended for the MOCVD method, do not have good stability for long term storage or vaporization characteristics, and it was impossible to stably transport the raw material to the CVD reaction unit by means of heating at a low temperature. Furthermore, when the raw material was heated to high temperature in order to increase the vaporization efficiency, the raw material was transported while thermally decomposing before reaching the film forming chamber, thus causing poor crystallinity or composition deviance in the film. Accordingly, it was difficult to stably transport the organometallic compound raw materials to the film forming chamber, the expensive raw materials had to be disposed after every incidence of film formation, and the control of the film composition was difficult, thus it being impossible to form dielectric films having good dielectric properties. Moreover, in the present method, when the time for synthesis (reaction) was extended by impeding the vaporization rate, the stability of the raw material deteriorated over time, with its vaporizability being gradually decreased. Therefore, the composition of the formed film became inhomogeneous along the thickness direction, and increase in the current leakage was unavoidable.

As a solution for the above-mentioned problems, an oxide-based CVD raw material for dielectric thin film has been disclosed, in which an organometallic compound is dissolved in tetrahydrofuran (hereinafter, referred to as THF), or in a solvent containing THF (See, for example, JP-A-6-158328 (claims 1 and 2). JP-A-6-158328 describes that film formation is performed according to a method called solution vaporization CVD, in which a raw material solution which is used as the raw material for CVD, is prepared by dissolving an organometallic compound in THF; the raw material solution is supplied, in its liquid state, to a vaporization chamber located in front of the film forming chamber; and the vapor resulting from the vaporization in this vaporization chamber is sent to the film forming chamber to form a film. Since the raw material is in a solution state, and especially since the dpm complex is stable, repeated use of the raw material is possible. It is also described that since the heating temperature for vaporization is lowered as well, thermal decomposition before reaching the film forming chamber can be avoided, the controllability for the film composition is enhanced.

In addition, a metal compound solution prepared by dissolving a metal compound in cyclohexane compound is disclosed (See, for example, JP-A-2001-234343 (claim 1, paragraphs [0006] and [0044])). It is described that the metal compound solution disclosed in JP-A-2001-234343 can provide a raw material for CVD having the stability and concentration that are appropriate for the solution vaporization CVD method.

However, even though a dielectric thin film is formed by the MOCVD method using the raw material for CVD described in JP-A-6-158328, control of the composition is still quite difficult, and thin films having the desired composition cannot be easily obtained. Specifically, raw materials such as Ti(i-Pr-O)₄ and Ba(dpm)₂ have a tendency to react with THF at room temperature in the presence of THF, and form non-volatile reaction products. Thus, only a part of the raw material present in the solution undergoes vaporization, and the amount of the raw material that is capable of undergoing vaporization is considered to be reduced to a large extent.

Sr(dpm)₂ is stable in THF at room temperature; however, in the presence of THF, this polar solvent solvates the complex, and thus, Sr(dpm)₂ exists in the form of Sr(dpm)₂Lₙ is THF, and n is an integer), the latter being vaporized. However, during the vaporization, since the evaporation temperature of the solid raw material Sr(dpm)₂ and that of the liquid Lₙ significantly differ from each other, Lₙ dissociates under heat during the process, and it is likely that transportation of the Sr raw material to the film forming chamber does not occur. Furthermore, with respect to the organic lead compound raw materials, β-diketone compounds as the organometallic compound induce clouding and precipitation in polar solvents such as THF, unlike other organometallic compounds, thus causing problems in the thin film preparation. Moreover, THF is polymerizable and undergoes ring-opening polymerization when heated for vaporization, and thus, the complex may become unstable.

The metal compound solution described in JP-A-2001-234343 uses cyclohexane as the solvent, and thus, a high rate of film formation or stability in film formation can be attained. However, since this cyclohexane has a high melting point, in the case of storing or transporting the raw material solution, in which an organometallic compound is dissolved in cyclohexane, in storage containers or the like, the raw material solution in the storage containers freezes in places such as cold regions where the temperature is lower than the melting point of cyclohexane, and particles and the like are generated, thereby the stability in film formation being declined.

### DISCLOSURE OF THE INVENTION

An object of the present invention is to provide a raw material solution for metal organic chemical vapor deposition having excellent controllability for film composition and step coverage, and an oxide-based dielectric thin film produced by using the raw material. Another object of the invention is to provide a raw material solution for metal organic chemical vapor deposition, which hardly freezes even in cold regions.

The first aspect of the present invention can be directed to an improvement in the raw material solution for metal organic chemical vapor deposition, in which one or two or more organometallic compounds are dissolved in an organic solvent. The feature of the constitution lies in that the organic solvent is 1,3-dioxolane.

In the first aspect of the present invention, a raw material solution having good film forming properties and excellent step coverage is obtained by using 1,3-dioxolane, which has good film forming properties and excellent step coverage, as the organic solvent.

The second aspect of the present invention can be directed to an improvement in the raw material solution for metal organic chemical vapor deposition, in which one or two or more organometallic compounds are dissolved in an organic solvent. The feature of the constitution lies in that the organic solvent is a solvent mixture formed by mixing a first solvent consisting of 1,3-dioxolane, and a second solvent including one or two or more species selected from the group consisting of alcohols, alkanes, esters, aromatics, alkyl ethers and ketones, which is to be mixed with the 1,3-dioxolane.

In the second aspect of the present invention, a raw material solution having better film forming properties and excellent step coverage is obtained, by using an organic solvent which includes 1,3-dioxolane having good film forming properties and excellent step coverage as an essential component, and which is a solvent mixture formed by mixing this 1,3-dioxolane with one or two or more of the above-listed various solvents having high solubility for organometallic compounds.

In the second aspect of the present invention, the second solvent may be cyclohexane.

The second solvent may be formed by mixing cyclohexane with one or two or more solvents selected from the group consisting of alcohols, alkanes, esters, aromatics, alkyl ethers and ketones. The invention can be directed to an improvement in the raw material solution for metal organic chemical vapor deposition, in which one or two or more organometallic compounds are dissolved in an organic solvent. The feature of the constitution lies in that the organic solvent includes cyclohexane as an essential solvent, and includes a solvent mixture formed by mixing this cyclohexane with one or two or more solvents selected from the group consisting of alcohols, alkanes, esters, aromatics, alkyl ethers and ketones.

In the invention, a raw material solution which hardly freezes even in cold regions and has good film forming properties and excellent step coverage, is obtained, by using an organic solvent which includes cyclohexane having good film forming properties and excellent step coverage as an essential component, and which includes a solvent mixture formed by mixing this cyclohexane with one or two or more of the above-listed various solvents having low melting points and high solubility for organometallic compounds.

In the first aspect and the second aspect of the present invention, the metal constituting the organometallic compound may be Ba, Sr, Pb, Zr, Ti, Nb or Hf, and the ligand may include either an alkoxide compound or a β-diketonate compound, or both.

The alcohol may be ethanol, n-propanol, i-propanol or n-butanol.

The alkane may be n-hexane, 2,2,4-trimethylpentane, n-octane, i-octane or methylcyclopentane. The aromatic may be toluene, xylene or benzene. The alkyl ether may be di-n-butyl ether, diisopentyl ether or polytetrahydrofuran (hereinafter, referred to as poly-THF). The ester may be butyl acetate.

The ketone may be acetone.

### BRIEF DESCRIPTION OF THE DRAWINGS

FIG. 1 is a schematic diagram of an MOCVD apparatus, which makes use of the solution vaporization CVD method that is used as the preparation method of the present invention.

FIG. 2 is a cross-sectional view of the substrate, shown to explain the method of determining the step coverage when film formation is performed by the MOCVD method.

### DETAILED DESCRIPTION OF THE INVENTION

The composite oxide-based dielectric thin film that can be formed from the raw material solution for the MOCVD method according to the invention, may be exemplified by the thin films made of lead titanate (PT), lead zirconate titanate (PZT), lead lanthanum zirconate titanate (PLZT), strontium titanate (ST), barium titanate (BT), barium strontium titanate (BST) and the like, but other oxides are also applicable.

The raw material solution for the MOCVD method of the invention is an improvement of the raw material solution formed by dissolving one or two or more organometallic compounds in an organic solvent. The organometallic compound to be used as the raw material of film, may be exemplified by organic compounds containing metals selected from Pb, Ti, Zr and alkaline earth metals (Ca, Ba, Sr, etc.), which are the constituent metals of the thin film. In addition to these, alkali metals (Cs), various transition metals such as Mn, Nb, V, Hf, Ta and the like, rare earth metals such as La, as well as Bi and Si are also used. In the case of BST thin film, respective organometallic compounds of Ti, Ba and Sr are used as the raw materials.

For the organometallic compound, those which are vaporizable, and which are thermally decomposed by heating and are easily convertible to oxides when an oxidizing agent (oxygen) is introduced, are used. Such an organometallic compound is generally a compound having a structure in which a metal atom is bound to an organic group through an oxygen atom. Preferred examples of this kind of compound include metal alkoxides, metal-β-diketonate complexes, complexes containing both of alkoxide and β-diketonate, mixtures of metal alkoxide and metal-β-diketonate complexes and the like. Examples of the β-diketonate complex include metal complexes having β-diketones such as acetylacetone, hexafluoroacetylacetone, dpm, pentafluoropropanoylpivaloylmethane and the like, as the ligand. Among these, preferred are the complexes having dpm. The metal alkoxide is preferably a metal alkoxide with the alkoxy group having 1 to 6 carbon atoms, and particularly preferably a metal alkoxide having a branched alkoxy group (isopropoxide, tert-butoxide, etc.). A particularly preferred organometallic compound is a metal dipivaloylmethanate complex, a metal isopropoxide, a metal tert-butoxide, a complex containing both of isopropoxide and dipivaloylmethanate, or a complex containing both of tert-butoxide and dipivaloylmethanate. In regard to the alkaline earth metals, alkali metals and Pb, it is preferable to use β-diketonate complexes (for example, dipivaloylmethanate complex), while in regard to the transition metals such as Ti, Zr, V, Nb and the like, it is generally possible to use either β-diketonate complexes or metal alkoxides, or also possibly complexes containing both of alkoxide and β-diketonate.

As the raw material for the formation of BST thin film, it is preferable to use dipivaloylmethanate complexes of Ba and Sr, and Ti compounds selected from isopropoxide, tert-butoxide, dipivaloylmethanate complex, complex containing both of isopropoxide and dipivaloylmethanate, and complex containing both of tert-butoxide and dipivaloylmethanate. Also, as the raw material for the formation of PZT thin film, it is preferable to use Pb-dipivaloylmethanate complex, Zr compounds including β-diketone and alkoxide, and Ti compounds selected from the group consisting of isopropoxide, tert-butoxide, dipivaloylmethanate complex, complex containing both of isopropoxide and dipivaloylmethanate, and complex containing both of tert-butoxide and dipivaloylmethanate.

The feature of the first constitution of the invention lies in that the organic solvent is 1,3-dioxolane. A raw material solution having good film forming properties and excellent step coverage is obtained by using 1,3-dioxolane, which has good film forming properties and excellent step coverage, as the organic solvent.

The feature of the second constitution of the invention lies in that the organic solvent is a solvent mixture formed by mixing a first solvent consisting of 1,3-dioxolane, and a second solvent comprising one or two or more species selected from the group consisting of alcohols, alkanes, esters, aromatics, alkyl ethers and ketones, which is to be mixed with 1,3-dioxolane. A raw material solution having better film forming properties and excellent step coverage is obtained, by using an organic solvent which comprises 1,3-dioxolane having good film forming properties and excellent step coverage as an essential component, and which is a solvent mixture formed by mixing this 1,3-dioxolane with one or two or more of the above-listed various solvents having high solubility for organometallic compounds.

The mixing ratio of the first solvent and the second solvent can be adjusted such that the weight ratio of the first solvent/the second solvent ranges from 99 to 1, but the mixing ratio is preferably such that the ratio of the first solvent/the second solvent ranges from 80 to 20. The raw material solution for MOCVD may be at any concentration, provided that a stable raw material solution can be provided without any limitation imparted by the particular concentration, and the concentration may be appropriately selected in accordance with the amount of the raw material transported, the film forming rate in the film production process, and the like.

The feature of the third constitution of the invention lies in that the organic solvent is a solvent mixture formed by mixing a first solvent consisting of 1,3-dioxolane, and a second solvent consisting of cyclohexane.

The feature of the fourth constitution of the invention lies in that the second solvent comprises cyclohexane as an essential solvent, and is a solvent mixture formed by mixing the cyclohexane with one or two or more solvents selected from the group consisting of alcohols, alkanes, esters, aromatics, alkyl ethers and ketones. A raw material solution which hardly freezes even in cold regions, and has excellent controllability for film composition and step coverage, is obtained by using a second solvent which comprises cyclohexane having excellent controllability for film composition and step coverage as an essential component, and which is a solvent mixture formed by mixing this cyclohexane with one or two or more of the above-listed various solvents having low melting points and high solubility for organometallic compounds. The raw material solution for MOCVD may be at any concentration, provided that a stable raw material solution can be provided without any limitation imparted by the particular concentration, and the concentration may be appropriately selected in accordance with the amount of the raw material transported, the film forming rate in the film production process, and the like.

The alcohol may be exemplified by ethanol, n-propanol, i-propanol, n-butanol, or the like. The alkane may be exemplified by n-hexane, 2,2,4-trimethylpentane, n-octane, i-octane, or methylcyclopentane. The ester may be exemplified by butyl acetate. The aromatic may be exemplified by toluene, xylene or benzene. The alkyl ether may be exemplified by di-n-butyl ether, diisopentyl ether, or poly-THF. The ketone may be exemplified by acetone.

Next, an example of forming a PZT thin film by the solution vaporization CVD method, by using raw material solutions having an organic Pb compound, an organic Zr compound and an organic Ti compound respectively dissolved in an organic solvent at predetermined proportions, will be described. The solution vaporization CVD method refers to a method of supplying each of the solutions to a heated vaporization vessel, where each raw material solution is instantly vaporized and sent to a film forming chamber to be formed into a film on a substrate.

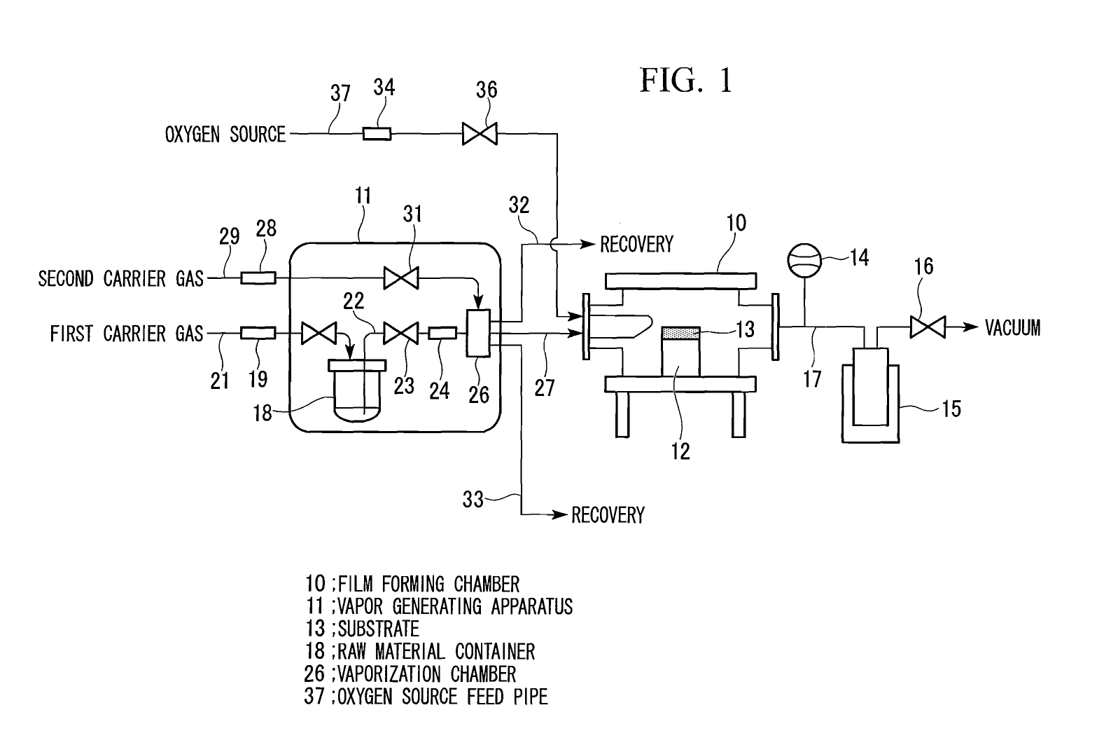

As shown in FIG. 1, the MOCVD apparatus includes a film forming chamber 10 and a vapor generating apparatus 11. A heater 12 is installed inside the film forming chamber 10, and a substrate 13 is maintained on the heater 12. The interior of the film forming chamber 10 is evacuated by a pipeline 17 equipped with a pressure sensor 14, a cold trap 15 and a needle valve 16. An oxygen source feed pipe 37 is connected to the film forming chamber 10 through a needle valve 36, and a gas flow rate control device 34. The vapor generating apparatus 11 includes a raw material container 18, and this raw material container 18 stores the raw material solution of the invention under sealing. To the raw material container 18, a first carrier gas feed pipe 21 is connected through a gas flow rate control device 19, and a feed pipe 22 is also connected to the raw material container 18. The feed pipe 22 is equipped with a needle valve 23 and a solution flow rate control device 24, and the feed pipe 22 is connected to a vaporization vessel 26. A second carrier gas feed pipe 29 is connected to the vaporization vessel 26 through a needle valve 31 and a gas flow rate control device 28. The vaporization vessel 26 is further connected to the film forming chamber 10 through a pipeline 27. To the vaporization vessel 26, a gas drain 32 and a drain 33 are respectively connected.

In this apparatus, a first carrier gas consisting of an inert gas such as N₂, He, Ar or the like is supplied to the raw material container 18 through the first carrier gas feed pipe 21, and conveys the raw material solution stored in the raw material container 18 by means of the pressure of the carrier gas supplied to the raw material container 18, through the feed pipe 22 to the vaporization vessel 26. Each of the organometallic compounds, which has been vaporized in the vaporization vessel 26 to become a vapor, is further supplied through the pipe 27 to the film forming chamber 10, by means of a second carrier gas consisting of an inert gas such as N₂, He, Ar or the like, which is supplied from the second carrier gas feed pipe 28 to the vaporization vessel 26.

In the film forming chamber 10, the vapor of each organometallic compound is thermally decomposed and reacted with the oxygen source supplied to the film forming chamber through the oxygen source feed pipe 37, and the metal oxides thus produced are deposited on the substrate 13, which has been heated, to form a PZT dielectric thin film having predetermined composition ratios.

The raw material solution of the invention is such that each raw material compound being in the solution state has stable vaporizability, and thus, the proportions of metal atoms in the formed thin film are almost consistent with the proportions of metal atoms in the solution. Therefore, a composite oxide-based dielectric thin film having a stable predetermined composition can be formed, and the film quality is stable.

The dielectric thin film formed by MOCVD using the raw material solution of the invention is useful in the applications such as DRAM, FRAM and the like. The MOCVD method generally provides excellent in step coverage, but when the raw material solution of the invention is used, the reproducibility of film formation is enhanced, as compared with the thin films formed by using conventional raw material solutions, and the surface morphology is stabilized.

In addition, the raw material solution of the invention provides excellent controllability for the film composition since the respective vapors of the raw material compounds can be supplied stably to the film forming chamber as described above, and thus, a dielectric thin film having excellent dielectric properties due to the desired composition can be stably formed on the substrate. The dielectric thin film formed by using the raw material solution of the invention can be used as a dielectric filter in piezoelectric resonators, infrared sensors and the like.

Next, Examples of the present invention will be described in detail, in association with Comparative Examples.

### EXAMPLE 1

First, there were provided Pb(dpm)₂ as an organic Pb compound, Zr(dmhd)₄ as an organic Zr compound, and Ti(O-i-Pr)₂(dpm)₂ as an organic Ti compound. Here, dmhd refers to 2,6-dimethyl-3,5-heptanedione residue, while O-i-Pr refers to isopropoxide. The compounds Pb(dpm)₂, Zr(dmhd)₄ and Ti(O-i-Pr)₂(dpm)₂ were mixed to a composition ratio of Pb_{1.15}(Zr_{0.45}Ti_{0.55})O₃, which ratio was expected in the formation, and were dissolved in the organic solvents presented in the following Table 1 to Table 3, to prepare 0.3 mol/L raw material solutions No. 1 through No. 15-4, respectively. O₂ was provided as the oxygen source.

Subsequently, a Pt (200 nm)/Ti (20 nm)/SiO₂ (500 nm)/Si substrate was provided as the substrate, and this substrate was placed in the film forming chamber of the MOCVD apparatus shown in FIG. 1. Also, a prepared raw material solution was stored in the raw material container 18. Next, the temperature of the substrate 13 was set to 600° C., the temperature of the vaporization chamber 26 was set to 250° C., and the pressure inside the film forming chamber 10 was set to about 1.33 kPa (10 Torr). The oxygen source supplied to the film forming chamber 10 was adjusted to a feed rate of 1200 ccm. Then, He gas as the first carrier gas was supplied into the raw material container 18, and thereby the raw material solution was supplied to the vaporization chamber 26 at a feed rate of 0.5 ccm. Furthermore, He gas as the second carrier gas was supplied to the vaporization chamber 26, and the raw material solution vaporized in the vaporization chamber 26 was supplied to the film forming chamber 10 to form Pb_{1.15}(Zr_{0.45}Ti_{0.55})O₃ on the surface of the substrate 13. After a time for film formation of 10 to 30 minutes elapsed, the substrate 13 was removed from the film forming chamber 10, and the substrate was obtained with a PZT dielectric thin film having a predetermined thickness formed thereon.

### COMPARATIVE EXAMPLE 1

A PZT dielectric thin film was formed in the same manner as in Example 1, except that a single solvent consisting of 100% by weight of THF was used as the organic solvent.

### Comparison Test 1

In order to confirm as to whether the PZT dielectric thin films respectively obtained in Example 1 and Comparative Example 1 have high remanent polarization values, the measurement of remanent polarization value and the step coverage test described below were carried out with respect to the thin films. The results are presented in Table 1 to Table 3.

(1) Measurement of remanent polarization value

On the substrate obtained after the completion of film formation, an upper electrode was formed with Pt to a thickness of 200 nm, and the remanent polarization value of the PZT dielectric thin film was measured by using a ferroelectric tester (Radiant Technology Corp.; RT6000S).

(2) Step coverage test

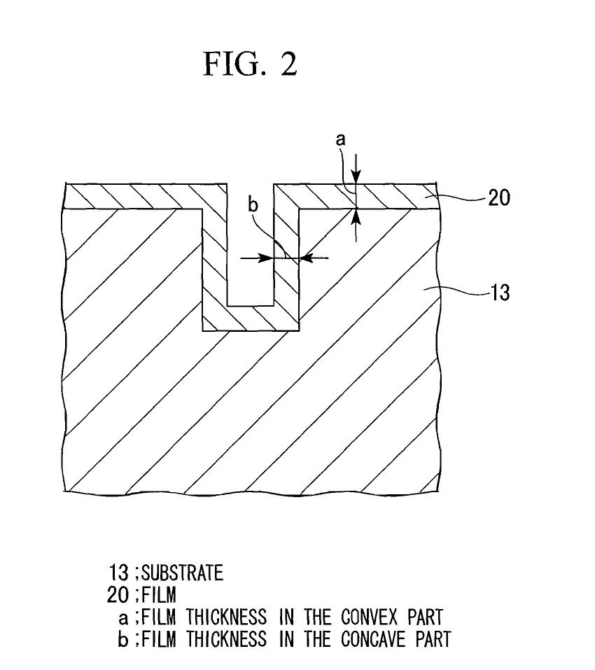

The step coverage of the PZT dielectric thin film on the substrate obtained after the completion of film formation, was measured from the cross-sectional SEM (scanning electron microscope) images. The step coverage is expressed as the value of a/b of when a thin film 20 is formed on the substrate 13 having unevenness such as grooves or the like, as shown in FIG. 2. When a/b is 1.0, film formation is achieved uniformly even to the interior of the grooves, similarly to the flat portions of the substrate, and thus, the step coverage can be said to be good. On the contrary, as the value of a/b is less than 1.0 and is becoming smaller, or as the value is greater than 1.0 and is becoming larger, the step coverage is considered to be poor in the respective cases.

TABLE 1

| | Organic solvent [wt %] | | | | | | Remanent | |
|---|---|---|---|---|---|---|---|---|
| Raw material | First | | Second | | Second | | polarization | Step coverage |
| solution | solvent | Ratio | solvent 1 | Ratio | solvent 2 | Ratio | value [mC/cm²] | (a/b) |
| No. 1 | 1,3- | 100 | — | — | — | — | 30.1 | 0.90 |
| | Dioxolane | | | | | | | |
| No. 2-1 | 1,3- | 80 | i-Octane | 10 | n-Octane | 10 | 31.3 | 0.95 |
| | Dioxolane | | | | | | | |
| No. 2-2 | 1,3- | 60 | i-Octane | 20 | n-Octane | 20 | 30.8 | 0.93 |
| | Dioxolane | | | | | | | |
| No. 2-3 | 1,3- | 40 | i-Octane | 30 | n-Octane | 30 | 31.0 | 0.93 |
| | Dioxolane | | | | | | | |
| No. 2-4 | 1,3- | 20 | i-Octane | 40 | n-Octane | 40 | 31.2 | 0.92 |
| | Dioxolane | | | | | | | |
| No. 3-1 | 1,3- | 80 | i-Octane | 10 | Butyl | 10 | 30.8 | 0.95 |
| | Dioxolane | | | | acetate | | | |
| No. 3-2 | 1,3- | 60 | i-Octane | 20 | Butyl | 20 | 30.5 | 0.95 |
| | Dioxolane | | | | acetate | | | |
| No. 3-3 | 1,3- | 40 | i-Octane | 30 | Butyl | 30 | 30.6 | 0.92 |
| | Dioxolane | | | | acetate | | | |
| No. 3-4 | 1,3- | 20 | i-Octane | 40 | Butyl | 40 | 30.4 | 0.93 |
| | Dioxolane | | | | acetate | | | |
| No. 4-1 | 1,3- | 80 | Acetone | 10 | Butyl | 10 | 31.2 | 0.94 |
| | Dioxolane | | | | acetate | | | |
| No. 4-2 | 1,3- | 60 | Acetone | 20 | Butyl | 20 | 30.8 | 0.93 |
| | Dioxolane | | | | acetate | | | |
| No. 4-3 | 1,3- | 40 | Acetone | 30 | Butyl | 30 | 31.0 | 0.92 |
| | Dioxolane | | | | acetate | | | |
| No. 4-4 | 1,3- | 20 | Acetone | 40 | Butyl | 40 | 30.7 | 0.94 |
| | Dioxolane | | | | acetate | | | |
| No. 5-1 | 1,3- | 80 | Toluene | 10 | Acetone | 10 | 32.2 | 0.94 |
| | Dioxolane | | | | | | | |
| No. 5-2 | 1,3- | 60 | Toluene | 20 | Acetone | 20 | 31.5 | 0.92 |
| | Dioxolane | | | | | | | |
| No. 5-3 | 1,3- | 40 | Toluene | 30 | Acetone | 30 | 31.7 | 0.93 |
| | Dioxolane | | | | | | | |
| No. 5-4 | 1,3- | 20 | Toluene | 40 | Acetone | 40 | 31.9 | 0.91 |
| | Dioxolane | | | | | | | |
| No. 6-1 | 1,3- | 80 | n-Hexane | 10 | Toluene | 10 | 32.3 | 0.95 |
| | Dioxolane | | | | | | | |
| No. 6-2 | 1,3- | 60 | n-Hexane | 20 | Toluene | 20 | 31.9 | 0.94 |
| | Dioxolane | | | | | | | |
| No. 6-3 | 1,3- | 40 | n-Hexane | 30 | Toluene | 30 | 32.0 | 0.93 |
| | Dioxolane | | | | | | | |
| No. 6-4 | 1,3- | 20 | n-Hexane | 40 | Toluene | 40 | 31.8 | 0.94 |
| | Dioxolane | | | | | | | |
| No. 7-1 | 1,3- | 80 | Toluene | 10 | Methylcyclopentane | 10 | 32.3 | 0.92 |
| | Dioxolane | | | | | | | |
| No. 7-2 | 1,3- | 60 | Toluene | 20 | Methylcyclopentane | 20 | 31.9 | 0.92 |
| | Dioxolane | | | | | | | |
| No. 7-3 | 1,3- | 40 | Toluene | 30 | Methylcyclopentane | 30 | 32.3 | 0.94 |
| | Dioxolane | | | | | | | |
| No. 7-4 | 1,3- | 20 | Toluene | 40 | Methylcyclopentane | 40 | 31.6 | 0.93 |
| | Dioxolane | | | | | | | |

TABLE 2

| | | | | | | | Remanent | |
|---|---|---|---|---|---|---|---|---|
| Raw | Organic solvent [wt %] | | | | | | polarization | Step |
| material | First | | Second | | Second | | value | coverage |
| solution | solvent | Ratio | solvent 1 | Ratio | solvent 2 | Ratio | [mC/cm2] | (a/b) |
| No. 8-1 | 1,3- | 80 | n-Octane | 10 | — | — | 32.1 | 0.95 |
| | Dioxolane | | | | | | | |
| No. 8-2 | 1,3- | 60 | n-Octane | 20 | — | — | 31.7 | 0.92 |
| | Dioxolane | | | | | | | |
| No. 8-3 | 1,3- | 40 | n-Octane | 30 | — | — | 32.0 | 0.93 |
| | Dioxolane | | | | | | | |
| No. 8-4 | 1,3- | 20 | n-Octane | 40 | — | — | 32.0 | 0.95 |
| | Dioxolane | | | | | | | |
| No. 9-1 | 1,3- | 80 | n-Hexane | 20 | — | — | 32.0 | 0.90 |
| | Dioxolane | | | | | | | |
| No. 9-2 | 1,3- | 60 | n-Hexane | 40 | — | — | 31.8 | 0.96 |
| | Dioxolane | | | | | | | |
| No. 9-3 | 1,3- | 40 | n-Hexane | 60 | — | — | 31.7 | 0.97 |
| | Dioxolane | | | | | | | |
| No. 9-4 | 1,3- | 20 | n-Hexane | 80 | — | — | 31.8 | 0.95 |
| | Dioxolane | | | | | | | |
| No. 10-1 | 1,3- | 80 | Toluene | 20 | — | — | 32.0 | 0.96 |
| | Dioxolane | | | | | | | |
| No. 10-2 | 1,3- | 60 | Toluene | 40 | — | — | 31.8 | 0.94 |
| | Dioxolane | | | | | | | |
| No. 10-3 | 1,3- | 40 | Toluene | 60 | — | — | 32.0 | 0.95 |
| | Dioxolane | | | | | | | |
| No. 10-4 | 1,3- | 20 | Toluene | 80 | — | — | 31.7 | 0.93 |
| | Dioxolane | | | | | | | |
| No. 11-1 | 1,3 | 80 | i-Octane | 20 | — | — | 32.1 | 0.94 |
| | Dioxolane | | | | | | | |
| No. 11-2 | 1,3- | 60 | i-Octane | 40 | — | — | 31.9 | 0.94 |
| | Dioxolane | | | | | | | |
| No. 11-3 | 1,3- | 40 | i-Octane | 60 | — | — | 31.9 | 0.93 |
| | Dioxolane | | | | | | | |
| No. 11-4 | 1,3- | 20 | i-Octane | 80 | — | — | 31.8 | 0.94 |
| | Dioxolane | | | | | | | |
| No. 12-1 | 1,3- | 80 | Acetone | 20 | — | — | 32.1 | 0.91 |
| | Dioxolane | | | | | | | |
| No. 12-2 | 1,3- | 60 | Acetone | 40 | — | — | 31.7 | 0.92 |
| | Dioxolane | | | | | | | |
| No. 12-3 | 1,3- | 40 | Acetone | 60 | — | — | 31.9 | 0.91 |
| | Dioxolane | | | | | | | |
| No. 12-4 | 1,3- | 20 | Acetone | 80 | — | — | 31.6 | 0.90 |
| | Dioxolane | | | | | | | |
| No. 13-1 | 1,3- | 80 | Butyl | 20 | — | — | 31.9 | 0.91 |
| | Dioxolane | | acetate | | | | | |
| No. 13-2 | 1,3- | 60 | Butyl | 40 | — | — | 31.9 | 0.90 |
| | Dioxolane | | acetate | | | | | |
| No. 13-3 | 1,3- | 40 | Butyl | 60 | — | — | 31.8 | 0.92 |
| | Dioxolane | | acetate | | | | | |
| No. 13-4 | 1,3- | 20 | Butyl | 80 | — | — | 31.7 | 0.91 |
| | Dioxolane | | acetate | | | | | |

TABLE 3

| | | | | | | | Remanent | |
|---|---|---|---|---|---|---|---|---|
| Raw | Organic solvent [wt %] | | | | | | polarization | Step |
| material | First | | Second | | Second | | value | coverage |
| solution | solvent | Ratio | solvent 1 | Ratio | solvent 2 | Ratio | [mC/cm2] | (a/b) |
| No. 14-1 | 1,3- | 80 | Poly-THF | 20 | — | — | 32.1 | 0.95 |
| | Dioxolane | | | | | | | |
| No. 14-2 | 1,3- | 60 | Poly-THF | 40 | — | — | 31.8 | 0.94 |
| | Dioxolane | | | | | | | |
| No. 14-3 | 1,3- | 40 | Poly-THF | 60 | — | — | 32.0 | 0.96 |
| | Dioxolane | | | | | | | |
| No. 14-4 | 1,3- | 20 | Poly-THF | 80 | — | — | 31.9 | 0.93 |
| | Dioxolane | | | | | | | |
| No. 15-1 | 1,3- | 80 | Methylcyclopentane | 20 | — | — | 31.9 | 0.94 |
| | Dioxolane | | | | | | | |
| No. 15-2 | 1,3 | 60 | Methylcyclopentane | 40 | — | — | 32.5 | 0.93 |
| | Dioxolane | | | | | | | |
| No. 15-3 | 1,3- | 40 | Methylcyclopentane | 60 | — | — | 32.0 | 0.91 |
| | Dioxolane | | | | | | | |
| No. 15-4 | 1,3- | 20 | Methylcyclopentane | 80 | — | — | 32.1 | 0.92 |
| | Dioxolane | | | | | | | |
| Comp. Ex. 1 | THF | 100 | — | — | — | — | 25.0 | 0.51 |

As it is clear from Table 1 through Table 3, in Comparative Example 1 where THF is used as a single solvent, the remanent polarization value and the step coverage both had low values. Correspondingly, when the raw material solutions No. 1, and No. 2-1 to No. 15-4 of Example 1 were used, extremely excellent results were obtained, compared with the results of Comparative Example 1.

### EXAMPLE 2

First, there were provided Ba(dpm)₂ as an organic Ba compound, Sr(dpm)₂ as an organic Sr compound, and Ti(O-i-Pr)₂(dpm)₂ as an organic Ti compound. The compounds Ba(dpm)₂, Sr(dpm)₂ and Ti(O-i-Pr)₂(dpm)₂ were mixed to a composition ratio of (Ba_{0.7}Sr_{0.3})TiO₃, which ratio was expected in the formation, and were dissolved in the organic solvents presented in the following Table 4 to Table 6, to prepare 0.3 mol/L raw material solutions No. 16 through No. 30-4, respectively. O₂ was provided as the oxygen source.

Subsequently, a Pt (200 nm)/Ti (20 nm) /SiO₂ (500 nm)/Si substrate was provided as the substrate, and this substrate was placed in the film forming chamber of the MOCVD apparatus shown in FIG. 1. Also, a prepared raw material solution was stored in the raw material container 18. Next, temperature of the vaporization chamber 26 was set to 250° C., and the pressure inside the film forming chamber 10 was set to about 1.33 kPa (10 Torr). The oxygen source supplied to the film forming chamber 10 was adjusted to a feed rate of 1000 ccm. Then, He gas as the first carrier gas was supplied into the raw material container 18, and thereby the raw material solution was supplied to the vaporization chamber 26 at a feed rate of 0.5 ccm. Furthermore, He gas as the second carrier gas was supplied to the vaporization chamber 26, and the raw material solution vaporized in the vaporization chamber 26 was supplied to the film forming chamber 10 to form (Ba_{0.7}Sr_{0.3})TiO₃ on the surface of the substrate 13. After a time for film formation of 10 to 30 minutes elapsed, the substrate 13 was removed from the film forming chamber 10, and the substrate was obtained with a BST dielectric thin film having a predetermined thickness formed thereon.

### COMPARATIVE EXAMPLE 2

A BST dielectric thin film was formed in the same manner as in Example 2, except that a single solvent consisting of 100% by weight of THF was used as the organic solvent.

### Comparison Test 2

In order to confirm as to whether the BST dielectric thin films respectively obtained in Example 2 and Comparative Example 2 have high specific dielectric constants, the measurement of the specific dielectric constant was carried out with respect to the thin films. The results are presented in Table 4 to Table 6.

(1) Measurement of specific dielectric constant

On the substrate obtained after the completion of film formation, an upper electrode was formed with Pt to a thickness of 200 nm, and the specific dielectric constant of the BST dielectric thin film was measured by using an LCR meter (Hewlett-Packard Inc.; 4284A).

TABLE 4

| | | | | | | | Remanent | |
|---|---|---|---|---|---|---|---|---|
| Raw | Organic solvent [wt %] | | | | | | polarization | Step |
| material | First | | Second | | Second | | value | coverage |
| solution | solvent | Ratio | solvent 1 | Ratio | solvent 2 | Ratio | [mC/cm2] | (a/b) |
| No. 16 | 1,3- | 100 | — | — | — | — | 325.0 | 0.90 |
| | Dioxolane | | | | | | | |
| No. 17-1 | 1,3- | 80 | i-Octane | 10 | n-Octane | 10 | 355.0 | 0.98 |
| | Dioxolane | | | | | | | |
| No. 17-2 | 1,3- | 60 | i-Octane | 20 | n-Octane | 20 | 350.0 | 0.96 |
| | Dioxolane | | | | | | | |
| No. 17-3 | 1,3- | 40 | i-Octane | 30 | n-Octane | 30 | 353.0 | 0.97 |
| | Dioxolane | | | | | | | |
| No. 17-4 | 1,3- | 20 | i-Octane | 40 | n-Octane | 40 | 348.0 | 0.94 |
| | Dioxolane | | | | | | | |
| No. 18-1 | 1,3- | 80 | i-Octane | 10 | Butyl | 10 | 346.0 | 0.95 |
| | Dioxolane | | | | acetate | | | |
| No. 18-2 | 1,3- | 60 | i-Octane | 20 | Butyl | 20 | 343.0 | 0.94 |
| | Dioxolane | | | | acetate | | | |
| No. 18-3 | 1,3- | 40 | i-Octane | 30 | Butyl | 30 | 342.0 | 0.92 |
| | Dioxolane | | | | acetate | | | |
| No. 18-4 | 1,3- | 20 | i-Octane | 40 | Butyl | 40 | 346.0 | 0.94 |
| | Dioxolane | | | | acetate | | | |
| No. 19-1 | 1,3- | 80 | Acetone | 10 | Butyl | 10 | 346.0 | 0.94 |
| | Dioxolane | | | | acetate | | | |
| No. 19-2 | 1,3- | 60 | Acetone | 20 | Butyl | 20 | 344.0 | 0.92 |
| | Dioxolane | | | | acetate | | | |
| No. 19-3 | 1,3- | 40 | Acetone | 30 | Butyl | 30 | 343.0 | 0.93 |
| | Dioxolane | | | | acetate | | | |
| No. 19-4 | 1,3- | 20 | Acetone | 40 | Butyl | 40 | 345.0 | 0.94 |
| | Dioxolane | | | | acetate | | | |
| No. 20-1 | 1,3- | 80 | Toluene | 10 | Acetone | 10 | 344.0 | 0.92 |
| | Dioxolane | | | | | | | |
| No. 20-2 | 1,3- | 60 | Toluene | 20 | Acetone | 20 | 341.0 | 0.93 |
| | Dioxolane | | | | | | | |
| No. 20-3 | 1,3- | 40 | Toluene | 30 | Acetone | 30 | 342.0 | 0.93 |
| | Dioxolane | | | | | | | |
| No. 20-4 | 1,3- | 20 | Toluene | 40 | Acetone | 40 | 343.0 | 0.91 |
| | Dioxolane | | | | | | | |
| No. 21-1 | 1,3- | 80 | n-Hexane | 10 | Toluene | 10 | 358.0 | 0.99 |
| | Dioxolane | | | | | | | |
| No. 21-2 | 1,3- | 60 | n-Hexane | 20 | Toluene | 20 | 354.0 | 0.99 |
| | Dioxolane | | | | | | | |
| No. 21-3 | 1,3- | 40 | n-Hexane | 30 | Toluene | 30 | 357.0 | 0.97 |
| | Dioxolane | | | | | | | |
| No. 21-4 | 1,3- | 20 | n-Hexane | 40 | Toluene | 40 | 355.0 | 0.97 |
| | Dioxolane | | | | | | | |
| No. 22-1 | 1,3- | 80 | Toluene | 10 | Methylcyclopentane | 10 | 348.0 | 0.95 |
| | Dioxolane | | | | | | | |
| No. 22-2 | 1,3- | 60 | Toluene | 20 | Methylcyclopentane | 20 | 352.0 | 0.93 |
| | Dioxolane | | | | | | | |
| No. 22-3 | 1,3- | 40 | Toluene | 30 | Methylcyclopentane | 30 | 348.0 | 0.91 |
| | Dioxolane | | | | | | | |
| No. 22-4 | 1,3- | 20 | Toluene | 40 | Methylcyclopentane | 40 | 347.0 | 0.92 |
| | Dioxolane | | | | | | | |

TABLE 5

| Raw | Organic solvent [wt %] | | | | | | Remanent | Step |
|---|---|---|---|---|---|---|---|---|
| material | First | | Second | | Second | | polarizati | coverage |
| solution | solvent | Ratio | solvent 1 | Ratio | solvent 2 | Ratio | [mC/cm2] | (a/b) |
| No. 23-1 | 1,3- | 80 | n-Octane | 20 | — | — | 353.0 | 0.98 |
| | Dioxolane | | | | | | | |
| No. 23-2 | 1,3- | 60 | n-Octane | 40 | — | — | 348.0 | 0.96 |
| | Dioxolane | | | | | | | |
| No. 23-3 | 1,3- | 40 | n-Octane | 60 | — | — | 352.0 | 0.97 |
| | Dioxolane | | | | | | | |
| No. 23-4 | 1,3- | 20 | n-Octane | 80 | — | — | 350.0 | 0.96 |
| | Dioxolane | | | | | | | |
| No. 24-1 | 1,3- | 80 | n-Hexane | 20 | — | — | 350.0 | 0.95 |
| | Dioxolane | | | | | | | |
| No. 24-2 | 1,3- | 60 | n-Hexane | 40 | — | — | 347.0 | 0.98 |
| | Dioxolane | | | | | | | |
| No. 24-3 | 1,3- | 40 | n-Hexane | 60 | — | — | 350.0 | 0.97 |
| | Dioxolane | | | | | | | |
| No. 24-4 | 1,3- | 20 | n-Hexane | 80 | — | — | 351.0 | 0.96 |
| | Dioxolane | | | | | | | |
| No. 25-1 | 1,3- | 80 | Toluene | 20 | — | — | 360.0 | 0.99 |
| | Dioxolane | | | | | | | |
| No. 25-2 | 1,3- | 60 | Toluene | 40 | — | — | 358.0 | 0.97 |
| | Dioxolane | | | | | | | |
| No. 25-3 | 1,3- | 40 | Toluene | 60 | — | — | 356.0 | 0.98 |
| | Dioxolane | | | | | | | |
| No. 25-4 | 1,3- | 20 | Toluene | 80 | — | — | 355.0 | 0.98 |
| | Dioxolane | | | | | | | |
| No. 26-1 | 1,3- | 80 | i-Octane | 20 | — | — | 355.0 | 0.98 |
| | Dioxolane | | | | | | | |
| No. 26-2 | 1,3- | 60 | i-Octane | 40 | — | — | 353.0 | 0.97 |
| | Dioxolane | | | | | | | |
| No. 26-3 | 1,3- | 40 | i-Octane | 60 | — | — | 352.0 | 0.96 |
| | Dioxolane | | | | | | | |
| No. 26-4 | 1,3- | 20 | i-Octane | 80 | — | — | 353.0 | 0.95 |
| | Dioxolane | | | | | | | |
| No. 27-1 | 1,3- | 80 | Acetone | 20 | — | — | 342.0 | 0.91 |
| | Dioxolane | | | | | | | |
| No. 27-2 | 1,3- | 60 | Acetone | 40 | — | — | 337.0 | 0.92 |
| | Dioxolane | | | | | | | |
| No. 27-3 | 1,3- | 40 | Acetone | 60 | — | — | 339.0 | 0.94 |
| | Dioxolane | | | | | | | |
| No. 27-4 | 1,3- | 20 | Acetone | 80 | — | — | 335.0 | 0.93 |
| | Dioxolane | | | | | | | |
| No. 28-1 | 1,3- | 80 | Butyl | 20 | — | — | 344.0 | 0.93 |
| | Dioxolane | | acetate | | | | | |
| No. 28-2 | 1,3- | 60 | Butyl | 40 | — | — | 340.0 | 0.93 |
| | Dioxolane | | acetate | | | | | |
| No. 28-3 | 1,3- | 40 | Butyl | 60 | — | — | 341.0 | 0.92 |
| | Dioxolane | | acetate | | | | | |
| No. 28-4 | 1,3- | 20 | Butyl | 80 | — | — | 337.0 | 0.91 |
| | Dioxolane | | acetate | | | | | |

TABLE 6

| | | | | | | | Remanent | |
|---|---|---|---|---|---|---|---|---|
| Raw | Organic solvent [wt %] | | | | | | polarization | Step |
| material | First | | Second | | Second | | value | coverage |
| solution | solvent | Ratio | solvent 1 | Ratio | solvent 2 | Ratio | [mC/cm2] | (a/b) |
| No. 29-1 | 1,3- | 80 | Poly-THF | 20 | — | — | 350.0 | 0.95 |
| | Dioxolane | | | | | | | |
| No. 29-2 | 1,3- | 60 | Poly-THF | 40 | — | — | 342.0 | 0.92 |
| | Dioxolane | | | | | | | |
| No. 29-3 | 1,3- | 40 | Poly-THF | 60 | — | — | 345.0 | 0.93 |
| | Dioxolane | | | | | | | |
| No. 29-4 | 1,3- | 20 | Poly-THF | 80 | — | — | 340.0 | 0.94 |
| | Dioxolane | | | | | | | |
| No. 30-1 | 1,3- | 80 | Methylcyclopentane | 20 | — | — | 345.0 | 0.97 |
| | Dioxolane | | | | | | | |
| No. 30-2 | 1,3- | 60 | Methylcyclopentane | 40 | — | — | 351.0 | 0.95 |
| | Dioxolane | | | | | | | |
| No. 30-3 | 1,3- | 40 | Methylcyclopentane | 60 | — | — | 351.0 | 0.94 |
| | Dioxolane | | | | | | | |
| No. 30-4 | 1,3- | 20 | Methylcyclopentane | 80 | — | — | 345.0 | 0.96 |
| | Dioxolane | | | | | | | |
| Comp. Ex. 2 | THF | 100 | — | — | — | — | 280.0 | 0.60 |

As it is clear from Table 4 through Table 6, in Comparative Example 2 where THF was used as a single solvent, the specific dielectric constant and the step coverage both had low values. Correspondingly, when the raw material solutions No. 16, and No. 17-1 through No. 30-4 of Example 2 were used, higher specific dielectric constants compared with the results of Comparative Example 2, and good step coverage were obtained, thus presenting extremely excellent results.

### EXAMPLE 3

First, there were provided Pb(dpm)₂ as an organic Pb compound, Zr(dmhd)₄ as an organic Zr compound, and Ti(O-i-Pr)₂(dpm)₂ as an organic Ti compound. The compounds Pb(dpm)₂, Zr(dmhd)₄ and Ti(O-i-Pr)₂(dpm)₂ were mixed to a composition ratio of Pb_{1.15}(Zr_{0.45}Ti_{0.55})O₃, which ratio was expected in the formation, and were dissolved in the organic solvents presented in the following Table 7 to Table 9, to prepare 0.3 mol/L raw material solutions No. 31-1 through No. 45-4, respectively. The same process as in Example 1 was carried out using the above raw material solutions, and substrates with PZT dielectric thin films having a predetermined thickness formed thereon, were obtained.

### Comparison Test 3

For the PZT dielectric thin films obtained in Example 3, the measurement of the remanent polarization value and the step coverage test were carried out in the same manner as in Comparison Test 1. The results are presented in Table 7 to Table 9.

TABLE 7

| | | | | | | | Remanent | |
|---|---|---|---|---|---|---|---|---|
| Raw | Organic solvent [wt %] | | | | | | polarization | Step |
| material | Essential | | Other | | Other | | value | coverage |
| solution | solvent | Ratio | solvent 1 | Ratio | solvent 2 | Ratio | [mC/cm2] | (a/b) |
| No. 31-1 | 1,3- | 80 | Ethanol | 10 | n-Propanol | 10 | 31.0 | 0.94 |
| | Dioxolane | | | | | | | |
| No. 31-2 | 1,3- | 60 | Ethanol | 20 | n-Propanol | 20 | 30.5 | 0.94 |
| | Dioxolane | | | | | | | |
| No. 31-3 | 1,3- | 40 | Ethanol | 30 | n-Propanol | 30 | 30.7 | 0.93 |
| | Dioxolane | | | | | | | |
| No. 31-4 | 1,3- | 20 | Ethanol | 40 | n-Propanol | 40 | 30.3 | 0.92 |
| | Dioxolane | | | | | | | |
| No. 32-1 | 1,3- | 80 | Ethanol | 10 | i-Propanol | 10 | 32.0 | 0.95 |
| | Dioxolane | | | | | | | |
| No. 32-2 | 1,3- | 60 | Ethanol | 20 | i-Propanol | 20 | 31.5 | 0.94 |
| | Dioxolane | | | | | | | |
| No. 32-3 | 1,3- | 40 | Ethanol | 30 | i-Propanol | 30 | 31.4 | 0.94 |
| | Dioxolane | | | | | | | |
| No. 32-4 | 1,3- | 20 | Ethanol | 40 | i-Propanol | 40 | 31.2 | 0.93 |
| | Dioxolane | | | | | | | |
| No. 33-1 | 1,3- | 80 | Ethanol | 10 | n-Butanol | 10 | 31.8 | 0.94 |
| | Dioxolane | | | | | | | |
| No. 33-2 | 1,3- | 60 | Ethanol | 20 | n-Butanol | 20 | 31.4 | 0.94 |
| | Dioxolane | | | | | | | |
| No. 33-3 | 1,3- | 40 | Ethanol | 30 | n-Butanol | 30 | 31.5 | 0.94 |
| | Dioxolane | | | | | | | |
| No. 33-4 | 1,3- | 20 | Ethanol | 40 | n-Butanol | 40 | 30.9 | 0.92 |
| | Dioxolane | | | | | | | |
| No. 34-1 | 1,3- | 80 | n-Propanol | 10 | i-Propanol | 10 | 32.5 | 0.95 |
| | Dioxolane | | | | | | | |
| No. 34-2 | 1,3- | 60 | n-Propanol | 20 | i-Propanol | 20 | 31.9 | 0.94 |
| | Dioxolane | | | | | | | |
| No. 34-3 | 1,3- | 40 | n-Propanol | 30 | i-Propanol | 30 | 31.4 | 0.94 |
| | Dioxolane | | | | | | | |
| No. 34-4 | 1,3- | 20 | n-Propanol | 40 | i-Propanol | 40 | 30.9 | 0.94 |
| | Dioxolane | | | | | | | |
| No. 35-1 | 1,3- | 80 | n-Propanol | 10 | n-Butanol | 10 | 32.0 | 0.96 |
| | Dioxolane | | | | | | | |
| No. 35-2 | 1,3- | 60 | n-Propanol | 20 | n-Butanol | 20 | 31.8 | 0.96 |
| | Dioxolane | | | | | | | |
| No. 35-3 | 1,3- | 40 | n-Propanol | 30 | n-Butanol | 30 | 31.5 | 0.95 |
| | Dioxolane | | | | | | | |
| No. 35-4 | 1,3- | 20 | n-Propanol | 40 | n-Butanol | 40 | 31.5 | 0.93 |
| | Dioxolane | | | | | | | |
| No. 36-1 | 1,3- | 80 | i-Propanol | 10 | n-Butanol | 10 | 32.2 | 0.96 |
| | Dioxolane | | | | | | | |
| No. 36-2 | 1,3- | 60 | i-Propanol | 20 | n-Butanol | 20 | 32.4 | 0.96 |
| | Dioxolane | | | | | | | |
| No. 36-3 | 1,3- | 40 | i-Propanol | 30 | n-Butanol | 30 | 31.9 | 0.94 |
| | Dioxolane | | | | | | | |
| No. 36-4 | 1,3- | 20 | i-Propanol | 40 | n-Butanol | 40 | 31.7 | 0.94 |
| | Dioxolane | | | | | | | |

TABLE 8

| | | | | | | | Remanent | |
|---|---|---|---|---|---|---|---|---|
| Raw | Organic solvent [wt %] | | | | | | polarization | Step |
| material | Essential | | Other | | Other | | value | coverage |
| solution | solvent | Ratio | solvent 1 | Ratio | solvent 2 | Ratio | [mC/cm2] | (a/b) |
| No. 37-1 | 1,3- | 80 | Ethanol | 10 | n-Octane | 10 | 32.3 | 0.96 |
| | Dioxolane | | | | | | | |
| No. 37-2 | 1,3- | 60 | Ethanol | 20 | n-Octane | 20 | 32.4 | 0.95 |
| | Dioxolane | | | | | | | |
| No. 37-3 | 1,3- | 40 | Ethanol | 30 | n-Octane | 30 | 31.5 | 0.94 |
| | Dioxolane | | | | | | | |
| No. 37-4 | 1,3- | 20 | Ethanol | 40 | n-Octane | 40 | 31.2 | 0.93 |
| | Dioxolane | | | | | | | |
| No. 38-1 | 1,3- | 80 | Ethanol | 10 | Butyl | 10 | 32.1 | 0.95 |
| | Dioxolane | | | | acetate | | | |
| No. 38-2 | 1,3- | 60 | Ethanol | 20 | Butyl | 20 | 31.5 | 0.94 |
| | Dioxolane | | | | acetate | | | |
| No. 38-3 | 1,3- | 40 | Ethanol | 30 | Butyl | 30 | 31.3 | 0.94 |
| | Dioxolane | | | | acetate | | | |
| No. 38-4 | 1,3- | 20 | Ethanol | 40 | Butyl | 40 | 30.8 | 0.93 |
| | Dioxolane | | | | acetate | | | |
| No. 39-1 | 1,3- | 80 | Ethanol | 10 | Acetone | 10 | 31.3 | 0.93 |
| | Dioxolane | | | | | | | |
| No. 39-2 | 1,3- | 60 | Ethanol | 20 | Acetone | 20 | 31.4 | 0.93 |
| | Dioxolane | | | | | | | |
| No. 39-3 | 1,3- | 40 | Ethanol | 30 | Acetone | 30 | 30.9 | 0.93 |
| | Dioxolane | | | | | | | |
| No. 39-4 | 1,3- | 20 | Ethanol | 40 | Acetone | 40 | 30.7 | 0.93 |
| | Dioxolane | | | | | | | |
| No. 40-1 | 1,3- | 80 | n-Propanol | 10 | Toluene | 10 | 32.1 | 0.96 |
| | Dioxolane | | | | | | | |
| No. 40-2 | 1,3- | 60 | n-Propanol | 20 | Toluene | 20 | 31.5 | 0.94 |
| | Dioxolane | | | | | | | |
| No. 40-3 | 1,3- | 40 | n-Propanol | 30 | Toluene | 30 | 31.2 | 0.93 |
| | Dioxolane | | | | | | | |
| No. 40-4 | 1,3- | 20 | n-Propanol | 40 | Toluene | 40 | 30.8 | 0.93 |
| | Dioxolane | | | | | | | |
| No. 41-1 | 1,3- | 80 | n-Propanol | 10 | Methylcyclopentane | 10 | 32.4 | 0.96 |
| | Dioxolane | | | | | | | |
| No. 41-2 | 1,3- | 60 | n-Propanol | 20 | Methylcyclopentane | 20 | 32.1 | 0.95 |
| | Dioxolane | | | | | | | |
| No. 41-3 | 1,3- | 40 | n-Propanol | 30 | Methylcyclopentane | 30 | 31.8 | 0.94 |
| | Dioxolane | | | | | | | |
| No. 41-4 | 1,3- | 20 | n-Propanol | 40 | Methylcyclopentane | 40 | 31.5 | 0.93 |
| | Dioxolane | | | | | | | |

TABLE 9

| | | | | | | | Remanent | |
|---|---|---|---|---|---|---|---|---|
| Raw | Organic solvent [wt %] | | | | | | polarization | Step |
| material | Essential | | Other | | Other | | value | coverage |
| solution | solvent | Ratio | solvent 1 | Ratio | solvent 2 | Ratio | [mC/cm2] | (a/b) |
| No. 42-1 | 1,3- | 80 | Ethanol | 20 | — | — | 32.1 | 0.95 |
| | Dioxolane | | | | | | | |
| No. 42-2 | 1,3- | 60 | Ethanol | 40 | — | — | 32.0 | 0.94 |
| | Dioxolane | | | | | | | |
| No. 42-3 | 1,3- | 40 | Ethanol | 60 | — | — | 31.8 | 0.94 |
| | Dioxolane | | | | | | | |
| No. 42-4 | 1,3- | 20 | Ethanol | 80 | — | — | 30.4 | 0.93 |
| | Dioxolane | | | | | | | |
| No. 43-1 | 1,3- | 80 | n-Propanol | 20 | — | — | 32.4 | 0.95 |
| | Dioxolane | | | | | | | |
| No. 43-2 | 1,3- | 60 | n-Propanol | 40 | — | — | 32.1 | 0.94 |
| | Dioxolane | | | | | | | |
| No. 43-3 | 1,3- | 40 | n-Propanol | 60 | — | — | 30.9 | 0.95 |
| | Dioxolane | | | | | | | |
| No. 43-4 | 1,3- | 20 | n-Propanol | 80 | — | — | 31.4 | 0.95 |
| | Dioxolane | | | | | | | |
| No. 44-1 | 1,3- | 80 | i-Propanol | 20 | — | — | 32.5 | 0.96 |
| | Dioxolane | | | | | | | |
| No. 44-2 | 1,3- | 60 | i-Propanol | 40 | — | — | 32.1 | 0.95 |
| | Dioxolane | | | | | | | |
| No. 44-3 | 1,3- | 40 | i-Propanol | 60 | — | — | 32.0 | 0.95 |
| | Dioxolane | | | | | | | |
| No. 44-4 | 1,3- | 20 | i-Propanol | 80 | — | — | 31.5 | 0.94 |
| | Dioxolane | | | | | | | |
| No. 45-1 | 1,3- | 80 | n-Butanol | 20 | — | — | 32.4 | 0.96 |
| | Dioxolane | | | | | | | |
| No. 45-2 | 1,3- | 60 | n-Butanol | 40 | — | — | 32.1 | 0.95 |
| | Dioxolane | | | | | | | |
| No. 45-3 | 1,3- | 40 | n-Butanol | 60 | — | — | 32.0 | 0.95 |
| | Dioxolane | | | | | | | |
| No. 45-4 | 1,3- | 20 | n-Butanol | 80 | — | — | 31.5 | 0.94 |
| | Dioxolane | | | | | | | |

As it is clear from Table 7 through Table 9, when the raw material solutions No. 31-1 through No. 45-4 of Example 3 were used, high remanent polarization values and good step coverage were obtained, thus presenting extremely excellent results.

### EXAMPLE 4

First, there were provided Ba(dpm)₂ as an organic Ba compound, Sr(dpm)₂ as an organic Sr compound, and Ti(O-i-Pr)₂(dpm)₂ as an organic Ti compound. The compounds Ba(dpm)₂, Sr(dpm)₂ and Ti(O-i-Pr)₂(dpm)₂ were mixed to a composition ratio of (Ba_{0.7}Sr_{0.3})TiO₃, which ratio was expected in the formation, and were dissolved in the organic solvents presented in the following Table 10 to Table 12, to prepare 0.3 mol/L raw material solutions No. 46-1 through No. 60-4, respectively. The same process as in Example 2 was carried out using the above raw material solutions, and substrates with BST dielectric thin films having a predetermined thickness formed thereon, were obtained.

### Comparison Test 4

For the BST dielectric thin films obtained in Example 4, the measurement of the specific dielectric constant and the step coverage test were carried out in the same manner as in the Comparison Test 2. The results are presented in Table 10 to Table 12.

TABLE 10

| | | | | | | | Specific | |
|---|---|---|---|---|---|---|---|---|
| Raw | Organic solvent [wt %] | | | | | | dielectric | Step |
| material | Essential | | Other | | Other | | constant | coverage |
| solution | solvent | Ratio | solvent 1 | Ratio | solvent 2 | Ratio | [—] | (a/b) |
| No. 46-1 | 1,3- | 80 | Ethanol | 10 | n-Propanol | 10 | 334.0 | 0.96 |
| | Dioxolane | | | | | | | |
| No. 46-2 | 1,3- | 60 | Ethanol | 20 | n-Propanol | 20 | 329.0 | 0.94 |
| | Dioxolane | | | | | | | |
| No. 46-3 | 1,3- | 40 | Ethanol | 30 | n-Propanol | 30 | 321.0 | 0.94 |
| | Dioxolane | | | | | | | |
| No. 46-4 | 1,3- | 20 | Ethanol | 40 | n-Propanol | 40 | 315.0 | 0.92 |
| | Dioxolane | | | | | | | |
| No. 47-1 | 1,3- | 80 | Ethanol | 10 | i-Propanol | 10 | 332.0 | 0.95 |
| | Dioxolane | | | | | | | |
| No. 47-2 | 1,3- | 60 | Ethanol | 20 | i-Propanol | 20 | 330.0 | 0.95 |
| | Dioxolane | | | | | | | |
| No. 47-3 | 1,3- | 40 | Ethanol | 30 | i-Propanol | 30 | 325.0 | 0.94 |
| | Dioxolane | | | | | | | |
| No. 47-4 | 1,3- | 20 | Ethanol | 40 | i-Propanol | 40 | 320.0 | 0.93 |
| | Dioxolane | | | | | | | |
| No. 48-1 | 1,3- | 80 | Ethanol | 10 | n-Butanol | 10 | 335.0 | 0.95 |
| | Dioxolane | | | | | | | |
| No. 48-2 | 1,3- | 60 | Ethanol | 20 | n-Butanol | 20 | 331.0 | 0.95 |
| | Dioxolane | | | | | | | |
| No. 48-3 | 1,3- | 40 | Ethanol | 30 | n-Butanol | 30 | 328.0 | 0.93 |
| | Dioxolane | | | | | | | |
| No. 48-4 | 1,3- | 20 | Ethanol | 40 | n-Butanol | 40 | 321.0 | 0.93 |
| | Dioxolane | | | | | | | |
| No. 49-1 | 1,3- | 80 | n-Propanol | 10 | i-Propanol | 10 | 343.0 | 0.96 |
| | Dioxolane | | | | | | | |
| No. 49-2 | 1,3- | 60 | n-Propanol | 20 | i-Propanol | 20 | 341.0 | 0.95 |
| | Dioxolane | | | | | | | |
| No. 49-3 | 1,3- | 40 | n-Propanol | 30 | i-Propanol | 30 | 338.0 | 0.95 |
| | Dioxolane | | | | | | | |
| No. 49-4 | 1,3- | 20 | n-Propanol | 40 | i-Propanol | 40 | 330.0 | 0.94 |
| | Dioxolane | | | | | | | |
| No. 50-1 | 1,3- | 80 | n-Propanol | 10 | n-Butanol | 10 | 346.0 | 0.95 |
| | Dioxolane | | | | | | | |
| No. 50-2 | 1,3- | 60 | n-Propanol | 20 | n-Butanol | 20 | 338.0 | 0.95 |
| | Dioxolane | | | | | | | |
| No. 50-3 | 1,3- | 40 | n-Propanol | 30 | n-Butanol | 30 | 339.0 | 0.94 |
| | Dioxolane | | | | | | | |
| No. 50-4 | 1,3- | 20 | n-Propanol | 40 | n-Butanol | 40 | 335.0 | 0.94 |
| | Dioxolane | | | | | | | |
| No. 51-1 | 1,3- | 80 | i-Propanol | 10 | n-Butanol | 10 | 351.0 | 0.96 |
| | Dioxolane | | | | | | | |
| No. 51-2 | 1,3- | 60 | i-Propanol | 20 | n-Butanol | 20 | 347.0 | 0.96 |
| | Dioxolane | | | | | | | |
| No. 51-3 | 1,3- | 40 | i-Propanol | 30 | n-Butanol | 30 | 340.0 | 0.95 |
| | Dioxolane | | | | | | | |
| No. 51-4 | 1,3- | 20 | i-Propanol | 40 | n-Butanol | 40 | 335.0 | 0.94 |
| | Dioxolane | | | | | | | |

TABLE 11

| | | | | | | | Specific | |
|---|---|---|---|---|---|---|---|---|
| Raw | Organic solvent [wt %] | | | | | | dielectric | Step |
| material | Essential | | Other | | Other | | constant | coverage |
| solution | solvent | Ratio | solvent 1 | Ratio | solvent 2 | Ratio | [—] | (a/b) |
| No. 52-1 | 1,3- | 80 | Ethanol | 10 | n-Octane | 10 | 331.0 | 0.95 |
| | Dioxolane | | | | | | | |
| No. 52-2 | 1,3- | 60 | Ethanol | 20 | n-Octane | 20 | 330.0 | 0.95 |
| | Dioxolane | | | | | | | |
| No. 52-3 | 1,3- | 40 | Ethanol | 30 | n-Octane | 30 | 324.0 | 0.93 |
| | Dioxolane | | | | | | | |
| No. 52-4 | 1,3- | 20 | Ethanol | 40 | n-Octane | 40 | 320.0 | 0.93 |
| | Dioxolane | | | | | | | |
| No. 53-1 | 1,3- | 80 | Ethanol | 10 | Butyl | 10 | 330.0 | 0.95 |
| | Dioxolane | | | | acetate | | | |
| No. 53-2 | 1,3- | 60 | Ethanol | 20 | Butyl | 20 | 325.0 | 0.94 |
| | Dioxolane | | | | acetate | | | |
| No. 53-3 | 1,3- | 40 | Ethanol | 30 | Butyl | 30 | 321.0 | 0.93 |
| | Dioxolane | | | | acetate | | | |
| No. 53-4 | 1,3- | 20 | Ethanol | 40 | Butyl | 40 | 311.0 | 0.92 |
| | Dioxolane | | | | acetate | | | |
| No. 54-1 | 1,3- | 80 | Ethanol | 10 | Acetone | 10 | 325.0 | 0.95 |
| | Dioxolane | | | | | | | |
| No. 54-2 | 1,3- | 60 | Ethanol | 20 | Acetone | 20 | 321.0 | 0.94 |
| | Dioxolane | | | | | | | |
| No. 54-3 | 1,3- | 40 | Ethanol | 30 | Acetone | 30 | 318.0 | 0.94 |
| | Dioxolane | | | | | | | |
| No. 54-4 | 1,3- | 20 | Ethanol | 40 | Acetone | 40 | 309.0 | 0.93 |
| | Dioxolane | | | | | | | |
| No. 55-1 | 1,3- | 80 | Ethanol | 10 | Toluene | 10 | 320.0 | 0.95 |
| | Dioxolane | | | | | | | |
| No. 55-2 | 1,3- | 60 | Ethanol | 20 | Toluene | 20 | 321.0 | 0.94 |
| | Dioxolane | | | | | | | |
| No. 55-3 | 1,3- | 40 | Ethanol | 30 | Toluene | 30 | 320.0 | 0.93 |
| | Dioxolane | | | | | | | |
| No. 55-4 | 1,3- | 20 | Ethanol | 40 | Toluene | 40 | 315.0 | 0.93 |
| | Dioxolane | | | | | | | |
| No. 56-1 | 1,3- | 80 | Ethanol | 10 | Methylcyclopentane | 10 | 321.0 | 0.95 |
| | Dioxolane | | | | | | | |
| No. 56-2 | 1,3- | 60 | Ethanol | 20 | Methylcyclopentane | 20 | 308.0 | 0.93 |
| | Dioxolane | | | | | | | |
| No. 56-3 | 1,3- | 40 | Ethanol | 30 | Methylcyclopentane | 30 | 315.0 | 0.93 |
| | Dioxolane | | | | | | | |
| No. 56-4 | 1,3- | 20 | Ethanol | 40 | Methylcyclopentane | 40 | 311.0 | 0.93 |
| | Dioxolane | | | | | | | |

TABLE 12

| Raw | Organic solvent [wt %] | | | | | | Specific | Step |
|---|---|---|---|---|---|---|---|---|
| material | Essential | | Other | | Other | | dielectric | coverage |
| solution | solvent | Ratio | solvent 1 | Ratio | solvent 2 | Ratio | [—] | (a/b) |
| No. 57-1 | 1,3- | 80 | Ethanol | 20 | — | — | 329.0 | 0.95 |
| | Dioxolane | | | | | | | |
| No. 57-2 | 1,3- | 60 | Ethanol | 40 | — | — | 327.0 | 0.94 |
| | Dioxolane | | | | | | | |
| No. 57-3 | 1,3- | 40 | Ethanol | 60 | — | — | 315.0 | 0.93 |
| | Dioxolane | | | | | | | |
| No. 57-4 | 1,3- | 20 | Ethanol | 80 | — | — | 308.0 | 0.92 |
| | Dioxolane | | | | | | | |
| No. 58-1 | 1,3- | 80 | n-Propanol | 20 | — | — | 345.0 | 0.96 |
| | Dioxolane | | | | | | | |
| No. 58-2 | 1,3- | 60 | n-Propanol | 40 | — | — | 339.0 | 0.95 |
| | Dioxolane | | | | | | | |
| No. 58-3 | 1,3- | 40 | n-Propanol | 60 | — | — | 335.0 | 0.95 |
| | Dioxolane | | | | | | | |
| No. 58-4 | 1,3- | 20 | n-Propanol | 80 | — | — | 329.0 | 0.94 |
| | Dioxolane | | | | | | | |
| No. 59-1 | 1,3- | 80 | i-Propanol | 20 | — | — | 351.0 | 0.97 |
| | Dioxolane | | | | | | | |
| No. 59-2 | 1,3- | 60 | i-Propanol | 40 | — | — | 341.0 | 0.96 |
| | Dioxolane | | | | | | | |
| No. 59-3 | 1,3- | 40 | i-Propanol | 60 | — | — | 343.0 | 0.95 |
| | Dioxolane | | | | | | | |
| No. 59-4 | 1,3- | 20 | i-Propanol | 80 | — | — | 335.0 | 0.95 |
| | Dioxolane | | | | | | | |
| No. 60-1 | 1,3- | 80 | n-Butanol | 20 | — | — | 356.0 | 0.97 |
| | Dioxolane | | | | | | | |
| No. 60-2 | 1,3- | 60 | n-Butanol | 40 | — | — | 345.0 | 0.95 |
| | Dioxolane | | | | | | | |
| No. 60-3 | 1,3- | 40 | n-Butanol | 60 | — | — | 346.0 | 0.96 |
| | Dioxolane | | | | | | | |
| No. 60-4 | 1,3- | 20 | n-Butanol | 80 | — | — | 339.0 | 0.95 |
| | Dioxolane | | | | | | | |

As it is clear from Table 10 through Table 12, when the raw material solutions No. 46-1 through No. 60-4 of Example 4 were used, high specific dielectric constants and good step coverage were obtained, thus presenting extremely excellent results.

### EXAMPLE 5

First, there were provided Pb(dpm)₂ as an organic Pb compound, Zr(dmhd)₄ as an organic Zr compound, and Ti(O-i-Pr)₂(dpm)₂ as an organic Ti compound. Here, dmhd refers to 2,6-dimethyl-3,5-heptanedione residue, while O-i-Pr refers to isopropoxide. The compounds Pb(dpm)₂, Zr(dmhd)₄ and Ti(O-i-Pr)₂(dpm)₂ were mixed to a composition ratio of Pb_{1.15}(Zr_{0.45}Ti_{0.55})O₃, which ratio was expected in the formation, and were dissolved in the organic solvents presented in the following Table 13, to prepare 0.3 mol/L raw material solutions No. 61-1 through No. 62-4, respectively. O₂ was provided as the oxygen source.

Subsequently, a Pt (200 nm)/Ti (20 nm)/SiO₂ (500 nm)/Si substrate was provided as the substrate, and this substrate was placed in the film forming chamber of the MOCVD apparatus shown in FIG. 1. Also, a prepared raw material solution was stored in the raw material container 18. Next, the temperature of the substrate 13 was set to 600° C., the temperature of the vaporization chamber 26 was set to 250° C., and the pressure inside the film forming chamber 10 was set to about 1.33 kPa (10 Torr). The oxygen source supplied to the film forming chamber 10 was adjusted to a feed rate of 1200 ccm. Then, He gas as the first carrier gas was supplied into the raw material container 18, and thereby the raw material solution was supplied to the vaporization chamber 26 at a feed rate of 0.5 ccm. Furthermore, He gas as the second carrier gas was supplied to the vaporization chamber 26, and the raw material solution vaporized in the vaporization chamber 26 was supplied to the film forming chamber 10 to form Pb_{1.15}(Zr_{0.45}Ti_{0.55})O₃ on the surface of the substrate 13. After a time for film formation of 10 to 30 minutes elapsed, the substrate 13 was removed from the film forming chamber 10, and the substrate was obtained with a PZT dielectric thin film having a predetermined thickness formed thereon.

### COMPARATIVE EXAMPLE 5

A PZT dielectric thin film was formed in the same manner as in Example 5, except that a single solvent consisting of 100% by weight of cyclohexane as the organic solvent.

### COMPARATIVE EXAMPLE 6

A PZT dielectric thin film was formed in the same manner as in Example 5, except that a single solvent consisting of 100% by weight of THF was used as the organic solvent.

### Comparison Test 5

In order to confirm as to whether the PZT dielectric thin films respectively obtained in Example 5 and Comparative Examples 5 and 6 had high remanent polarization values, the measurement of the remanent polarization values and the step coverage test were carried out as follows with respect to the thin films. The results are presented in Table 13.

(1) Measurement of remanent polarization value

On the substrate obtained after the completion of film formation, an upper electrode was formed with Pt to a thickness of 200 nm, and the remanent polarization value of the PZT dielectric thin film was measured by using a ferroelectric tester (Radiant Technology Corp.; RT6000S).

(2) Step coverage test

The step coverage of the PZT dielectric thin film on the substrate obtained after the completion of film formation, was measured from the cross-sectional SEM (scanning electron microscope) images. The step coverage is expressed as the value of a/b of when a thin film 20 is formed on the substrate 13 having unevenness such as grooves or the like, as shown in FIG. 2. When a/b is 1.0, film formation is achieved uniformly even to the interior of the grooves, similarly to the flat portions of the substrate, and thus, the step coverage can be said to be good. On the contrary, as the value of a/b is less than 1.0 and is becoming smaller, or as the value is greater than 1.0 and is becoming larger, the step coverage is considered to be poor in the respective cases.

TABLE 13

| | | | | | | | Remanent | |
|---|---|---|---|---|---|---|---|---|
| Raw | Organic solvent [wt %] | | | | | | polarization | Step |
| material | First | | Second | | Second | | value | coverage |
| solution | solvent | Ratio | solvent 1 | Ratio | solvent 2 | Ratio | [mC/cm2] | (a/b) |
| No. 61-1 | 1,3- | 10 | Cyclohexane | 80 | n-Octane | 10 | 32.3 | 0.98 |
| | Dioxolane | | | | | | | |
| No. 61-2 | 1,3- | 20 | Cyclohexane | 60 | n-Octane | 20 | 32.0 | 0.96 |
| | Dioxolane | | | | | | | |
| No. 61-3 | 1,3- | 30 | Cyclohexane | 40 | n-Octane | 30 | 31.9 | 0.94 |
| | Dioxolane | | | | | | | |
| No. 61-4 | 1,3- | 40 | Cyclohexane | 20 | n-Octane | 40 | 32.1 | 0.97 |
| | Dioxolane | | | | | | | |
| No. 62-1 | 1,3- | 20 | Cyclohexane | 80 | — | — | 32.5 | 0.98 |
| | Dioxolane | | | | | | | |
| No. 62-2 | 1,3- | 40 | Cyclohexane | 60 | — | — | 32.3 | 0.96 |
| | Dioxolane | | | | | | | |
| No. 62-3 | 1,3- | 60 | Cyclohexane | 40 | — | — | 32.0 | 0.97 |
| | Dioxolane | | | | | | | |
| No. 62-4 | 1,3- | 80 | Cyclohexane | 20 | — | — | 32.3 | 0.95 |
| | Dioxolane | | | | | | | |
| Comp. Ex. 5 | Cyclohexane | 100 | — | — | — | — | 30.3 | 0.90 |
| Comp. Ex. 6 | THF | 100 | — | — | — | — | 25.0 | 0.51 |

As it is clear from Table 13, in Comparative Example 6 where THF was used as a single solvent, the remanent polarization value and the step coverage both had low values. Further, in Comparative Example 5 where cyclohexane was used as a single solvent, high remanent polarization value and good step coverage were obtained. However, when the raw material solutions are to be maintained in cold regions, there may be inconveniences such as freezing, and it is difficult to handle. Correspondingly, when the raw material solutions No. 61-1 through No. 62-4 of Example 5 were used, higher remanent polarization values compared with the results of Comparative Example 6 and good step coverage were obtained, thus presenting extremely excellent results. Also, even when compared with Comparative Example 5, results excellent in overall were obtained.

### EXAMPLE 6

First, there were provided Ba(dpm)₂ as an organic Ba compound, Sr(dpm)₂ as an organic Sr compound, and Ti(O-i-Pr)₂(dpm)₂ as an organic Ti compound. The compounds Ba(dpm)₂, Sr(dpm)₂ and Ti(O-i-Pr)₂(dpm)₂ were mixed to a composition ratio of (Ba_{0.7}Sr_{0.3})TiO₃, which ratio was expected in the formation, and were dissolved in the organic solvents presented in the following Table 14 to Table 16, to prepare 0.3 mol/L raw material solutions No. 63-1 through No. 64-4, respectively. O₂ was provided as the oxygen source.

Subsequently, a Pt (200 nm)/Ti (20 nm) /SiO₂ (500 nm)/Si substrate was provided as the substrate, and this substrate was placed in the film forming chamber of the MOCVD apparatus shown in FIG. 1. Also, a prepared raw material solution was stored in the raw material container 18. Next, the temperature of the substrate 13 was set to 700° C., the temperature of the vaporization chamber 26 was set to 250° C., and the pressure inside the film forming chamber 10 was set to about 1.33 kPa (10 Torr). The oxygen source supplied to the film forming chamber 10 was adjusted to a feed rate of 1000 ccm. Then, He gas as the first carrier gas was supplied into the raw material container 18, and thereby the raw material solution was supplied to the vaporization chamber 26 at a feed rate of 0.5 ccm. Furthermore, He gas as the second carrier gas was supplied to the vaporization chamber 26, and the raw material solution vaporized in the vaporization chamber 26 was supplied to the film forming chamber 10 to form (Ba_{0.7}Sr_{0.3})TiO₃ on the surface of the substrate 13. After a time for film formation of 10 to 30 minutes elapsed, the substrate 13 was removed from the film forming chamber 10, and the substrate was obtained with a BST dielectric thin film having a predetermined thickness formed thereon.

### COMPARATIVE EXAMPLE 7

A BST dielectric thin film was formed in the same manner as in Example 6, except that a single solvent consisting of 100% by weight of cyclohexane was used as the organic solvent.

### COMPARATIVE EXAMPLE 8

A BST dielectric thin film was formed in the same manner as in Example 6, except that a single solvent consisting of 100% by weight of THF was used as the organic solvent.

### Comparison Test 6

In order to confirm as to whether the BST dielectric thin films respectively obtained in Example 6 and Comparative Examples 7 and 8 had high specific dielectric constants, the specific dielectric constants of these thin films were measured. Further, the step coverage test was carried out in the same manner as in the Comparison test 5. The results are presented in Table 14.

(1) Measurement of specific dielectric constant

On the substrate obtained after the completion of film formation, an upper electrode was formed with Pt to a thickness of 200 nm, and the specific dielectric constant of the BST dielectric thin film was measured by using an LCR meter (Hewlett-Packard Inc.; 4284A).

TABLE 14

| | | | | | | | Specific | |
|---|---|---|---|---|---|---|---|---|
| Raw | Organic solvent [wt %] | | | | | | dielectric | Step |
| material | First | | Second | | Second | | constant | coverage |
| solution | solvent | Ratio | solvent 1 | Ratio | solvent 2 | Ratio | [—] | (a/b) |
| No. 63-1 | 1,3- | 10 | Cyclohexane | 80 | n-Octane | 10 | 358.0 | 0.99 |
| | Dioxolane | | | | | | | |
| No. 63-2 | 1,3- | 20 | Cyclohexane | 60 | n-Octane | 20 | 353.0 | 0.97 |
| | Dioxolane | | | | | | | |
| No. 63-3 | 1,3- | 30 | Cyclohexane | 40 | n-Octane | 30 | 355.0 | 0.98 |
| | Dioxolane | | | | | | | |
| No. 63-4 | 1,3- | 40 | Cyclohexane | 20 | n-Octane | 40 | 351.0 | 0.96 |
| | Dioxolane | | | | | | | |
| No. 64-1 | 1,3- | 20 | Cyclohexane | 80 | — | — | 358.0 | 0.97 |
| | Dioxolane | | | | | | | |
| No. 64-2 | 1,3- | 40 | Cyclohexane | 60 | — | — | 355.0 | 0.98 |
| | Dioxolane | | | | | | | |
| No. 64-3 | 1,3- | 60 | Cyclohexane | 40 | — | — | 359.0 | 0.97 |
| | Dioxolane | | | | | | | |
| No. 64-4 | 1,3- | 80 | Cyclohexane | 20 | — | — | 357.0 | 0.95 |
| | Dioxolane | | | | | | | |
| Comp. Ex. 7 | Cyclohexane | 100 | — | — | — | — | 330.0 | 0.91 |
| Comp. Ex. 8 | THF | 100 | — | — | — | — | 280.0 | 0.60 |

As it is clear from Table 14, in Comparative Example 8 where THF was used as a single solvent, the specific dielectric constant and the step coverage both had low values. Further, in Comparative Example 7 where cyclohexane was used as a single solvent, high specific specificity and good step coverage were obtained. However, when the raw material solutions are to be maintained in cold regions, there may be inconveniences such as freezing, and it is difficult to handle. Correspondingly, when the raw material solutions No. 63-1 through No. 64-4 of Example 6 were used, higher specific dielectric constants compared with the results of Comparative Example 6 and good step coverage were obtained, thus presenting extremely excellent results. Also, even when compared with Comparative Example 5, results excellent in overall were obtained.

### EXAMPLE 7

First, there were provided Pb(dpm)₂ as an organic Pb compound, Zr(dmhd)₄ as an organic Zr compound, and Ti(O-i-Pr)₂(dpm)₂ as an organic Ti compound. The compounds Pb(dpm)₂, Zr(dmhd)₄ and Ti(O-i-Pr)₂(dpm)₂ were mixed to a composition ratio of Pb_{1.15}(Zr_{0.45}Ti_{0.55})O₃, which ratio was expected in the formation, and were dissolved in the organic solvents presented in the following Table 15, to prepare 0.3 mol/L raw material solutions No. 65-1 through No. 65-4, respectively. The same process as in Example 5 was carried out using the above raw material solutions, and substrates with PZT dielectric thin films having a predetermined thickness formed thereon, were obtained.

### Comparison Test 7

For the PZT dielectric thin films obtained in Example 7, the measurement of the remanent polarization value and the step coverage test were carried out in the same manner as in the Comparison Test 5. The results are presented in Table 15.

TABLE 15

| | | | | | | | Remanent | Step |
|---|---|---|---|---|---|---|---|---|
| Raw | Organic solvent [wt %] | | | | | | polarization | coverage |
| material | First | | Second | | Second | | value | (a/b) |
| solution | solvent | Ratio | solvent 1 | Ratio | solvent 2 | Ratio | [mC/cm2] | [mC/cm2] |
| No. 65-1 | 1,3- | 10 | Cyclohexane | 80 | Ethanol | 10 | 32.1 | 0.95 |
| | Dioxolane | | | | | | | |
| No. 65-2 | 1,3- | 20 | Cyclohexane | 60 | Ethanol | 20 | 31.9 | 0.94 |
| | Dioxolane | | | | | | | |
| No. 65-3 | 1,3- | 30 | Cyclohexane | 40 | Ethanol | 30 | 31.5 | 0.93 |
| | Dioxolane | | | | | | | |
| No. 65-4 | 1,3- | 40 | Cyclohexane | 20 | Ethanol | 40 | 31.3 | 0.92 |
| | Dioxolane | | | | | | | |

As it is clear from Table 15, when the raw material solutions No. 65-1 through No. 65-4 of Example 7 were used, high remanent polarization values and good step coverage were obtained, thus presenting extremely excellent results.

### EXAMPLE 8

First, there were provided Ba(dpm)₂ as an organic Ba compound, Sr(dpm)₂ as an organic Sr compound, and Ti(O-i-Pr)₂(dpm)₂ as an organic Ti compound. The compounds Ba(dpm)₂, Sr(dpm)₂ and Ti(O-i-Pr)₂(dpm)₂ were mixed to a composition ratio of (Ba_{0.7}Sr_{0.3})TiO₃, which ratio was expected in the formation, and were dissolved in the organic solvents presented in the following Table 16, to prepare 0.3 mol/L raw material solutions No. 66-1 through No. 66-4, respectively. The same process as in Example 6 was carried out using the above raw material solutions, and substrates with BST dielectric thin films having a predetermined thickness formed thereon, were obtained.

### Comparison Test 8

For the BST dielectric thin films obtained in Example 8, the measurement of the specific dielectric constants and the step coverage test were carried out in the same manner as in the Comparison Test 6. The results are presented in Table 16.

TABLE 16

| | | | | | | | Specific | |
|---|---|---|---|---|---|---|---|---|
| Raw | Organic solvent [wt %] | | | | | | dielectric | Step |
| material | First | | Second | | Second | | constant | coverage |
| solution | solvent | Ratio | solvent 1 | Ratio | solvent 2 | Ratio | [—] | (a/b) |
| No. 66-1 | 1,3- | 10 | Cyclohexane | 80 | Ethanol | 10 | 343.0 | 0.95 |
| | Dioxolane | | | | | | | |
| No 66-2 | 1,3- | 20 | Cyclohexane | 60 | Ethanol | 20 | 337.0 | 0.93 |
| | Dioxolane | | | | | | | |
| No 66-3 | 1,3- | 30 | Cyclohexane | 40 | Ethanol | 30 | 335.0 | 0.93 |
| | Dioxolane | | | | | | | |
| No 66-4 | 1,3- | 40 | Cyclohexane | 20 | Ethanol | 40 | 331.0 | 0.92 |
| | Dioxolane | | | | | | | |

As it is clear from Table 16, when the raw material solutions No. 66-1 through No. 66-4 of Example 8 were used, high specific dielectric constants and good step coverage were obtained, thus presenting extremely excellent results.

In regard to the raw material solution for MOCVD according to the present invention, a raw material solution having good film forming properties and excellent step coverage is obtained by using 1,3-dioxolane which has good film forming properties and excellent step coverage, as an organic solvent.

Further, In regard to the raw material solution for MOCVD of the invention, a raw material solution having better film forming properties and excellent step coverage is obtained, when the organic solvent is a solvent mixture formed by mixing a first solvent consisting of 1,3-dioxolane, and a second solvent comprising one or two or more species selected from the group consisting of alcohols, alkanes, esters, aromatics, alkyl ethers and ketones, which is to be mixed with the 1,3-dioxolane, and when the organic solvent comprises 1,3-dioxolane having good film forming properties and excellent step coverage as an essential component, and is a solvent mixture formed by mixing this 1,3-dioxolane with one or two or more of the above-listed various solvents having high solubility for organometallic compounds.

In addition, in regard to the raw material solution for MOCVD of the invention, a raw material solution which hardly freezes even in cold regions, and has good film forming properties and excellent step coverage, is obtained, when the second solvent comprises cyclohexane as an essential component, and is a solvent mixture formed by mixing the cyclohexane with one or two or more solvents selected from the group consisting of alcohols, alkanes, esters, aromatics, alkyl ethers and ketones, and when the organic solvent used comprises cyclohexane having good film forming properties and excellent step coverage as an essential component, and is a solvent mixture formed by mixing this cyclohexane with one or two or more of the above-listed various solvents having low melting points and high solubility for organometallic compounds.

1. A raw material solution for metal organic chemical vapor deposition comprising one or two or more organometallic compounds dissolved in an organic solvent,
wherein the organic solvent is 1,3-dioxolane.

2. A raw material solution for metal organic chemical vapor deposition comprising one or two or more organometallic compounds dissolved in an organic solvent,
wherein the organic solvent is a solvent mixture formed by mixing a first solvent consisting of 1,3-dioxolane, and a second solvent comprising one or two or more species selected from the group consisting of alcohols, alkanes, esters, aromatics, alkyl ethers and ketones, which is to be mixed with the 1,3-dioxolane.

3. The raw material solution according to claim 2, wherein the second solvent is cyclohexane.

4. The raw material solution according to claim 2, wherein the second solvent is formed by mixing cyclohexane with one or two or more solvents selected from the group consisting of alcohols, alkanes, esters, aromatics, alkyl ethers and ketones.

5. The raw material solution according to claim 1, wherein the metal constituting the organometallic compound is selected from the consisting of Ba, Sr, Pb, Zr, Ti, Nb and Hf, and the ligand comprises an alkoxide compound or a β-diketonate compound, or both of the compounds.

6. The raw material solution according to claim 2, wherein the alcohol of the second solvent is selected from the group consisting of ethanol, n-propanol, i-propanol and n-butanol.

7. The raw material solution according to claim 2, wherein the alkane of the second solvent is selected from the group consisting of n-hexane, 2,2,4-trimethylpentane, n-octane, i-octane and methylcyclopentane.

8. The raw material solution according to claim 2, wherein the aromatic of the second solvent is selected from the group consisting of toluene, xylene and benzene.

9. The raw material solution according to claim 2, wherein the alkyl ether of the second solvent is selected from the group consisting of di-n-butyl ether, diisopentyl ether and polytetrahydrofuran.

10. The raw material solution according to claim 2, wherein the ester of the second solvent is butyl acetate.

11. The raw material solution according to claim 2, wherein the ketone of the second solvent is acetone.

12. The raw material solution according to claim 2, wherein the metal constituting the organometallic compound is selected from the group consisting of Ba, Sr, Pb, Zr, Ti, Nb and Hf, and the ligand comprises an alkoxide compound or a β-diketonate compound, or both of the compounds.

13. The raw material solution according to claim 4, wherein the metal constituting the organometallic compound is selected from the group consisting of Ba, Sr, Pb, Zr, Ti, Nb and Hf, and the ligand comprises an alkoxide compound or a β-diketonate compound, or both of the compounds.

14. The raw material solution according to claim 4, wherein the alcohol of the second solvent is selected from the group consisting of ethanol, n-propanol, i-propanol and n-butanol.

15. The raw material solution according to claim 4, wherein the alkane of the second solvent is selected from the group consisting of n-hexane, 2,2,4-trimethylpentane, n-octane, i-octane and methylcyclopentane.

16. The raw material solution according to claim 4, wherein the aromatic of the second solvent is selected from the group consisting of toluene, xylene and benzene.

17. The raw material solution according to claim 4, wherein the alkyl ether of the second solvent is selected from the group consisting of di-n-butyl ether, diisopentyl ether and polytetrahydrofuran.

18. The raw material solution according to claim 4, wherein the ester of the second solvent is butyl acetate.

19. The raw material solution according to claim 4, wherein the ketone of the second solvent is acetone.
